(19) United States
(12) Patent Application Publication
(10) Pub. No.: US 2015/0180179 A1
(43) Pub. Date: Jun. 25, 2015

(54) Connector Assembly

(71) Applicant: Tyco Electronics AMP Korea Ltd, Kyungsangbuk-do (KR)

(72) Inventors: Hye Jun Lee, Kyungsangbuk-do (KR); Jung Hoon Kim, Kyungsangbuk-do (KR)

(73) Assignee: Tyco Electronics AMP Korea Ltd, Kyungsangbuk-do (KR)

(21) Appl. No.: 14/576,979

(22) Filed: Dec. 19, 2014

(30) Foreign Application Priority Data
Dec. 19, 2013 (KR) 1020130159170
Apr. 15, 2014 (KR) 102014044559

(51) Int. Cl. H01R 13/66

(52) U.S. Cl. CPC H01R 13/6616

(57) ABSTRACT

An electrical connector assembly is disclosed having a body, a plurality of terminals, a resistor device, a housing, and a shell. The plurality of terminals are insert-molded in the body. The resistor device is positioned in the body and in contact with a power terminal. The housing has a body receiving space into which the body is positioned. The shell is connected to an outside of the housing.

### CROSS-REFERENCE TO RELATED APPLICATIONS

This application claims the benefit of the filing date under 35 U.S.C. §119(a)-(d) to Korean Patent Application No. 10-2013-0159170, filed on Dec. 19, 2013, and Korean Patent Application No. 10-2014-0044559, filed on Apr. 15, 2014.

### FIELD OF THE INVENTION

The invention generally relates to an electrical connector, and more specifically, to an electrical connector assembly with overcurrent protection.

### BACKGROUND

A safety control is often provided to protect components and systems in a vehicle and occupants of the vehicle. For example, vehicle components may be positioned in a power circuit to protect an output circuit and a downstream device from a power surge. A typical power system may include an overcurrent protection apparatus such as a fuse, a relay, a connector, and the like, to prevent overcurrent or overvoltage situation that may damage a downstream circuit.

When overcurrent flows in the electric circuit, the result is often either a temperature increase, or an increase in a resistance value, or both. Positive temperature coefficient (PTC) devices have been developed to detect these increases in temperature or resistance, and the PTC devices serve as a switch that activates to open the circuit when an increase in temperature is detected, thus serving to block the flow of the overcurrent.

While PTC devices are conventionally known, there is a need to integrate such PTC devices into electrical connector assemblies such that the PTC devices are in close proximity to power conducting terminals. By integrating such PTC devices, the sensitivity of these PTC devices can be increased.

### SUMMARY

An electrical connector assembly has a body, a plurality of terminals, a resistor device, a housing, and a shell. The plurality of terminals is insert-molded in the body. The resistor device is positioned in the body and in contact with a power terminal. The housing has a body receiving space into which the body is positioned. The shell is connected to an outside of the housing.

### BRIEF DESCRIPTION OF THE DRAWINGS

The invention will now be described by way of example, with reference to the accompanying Figures, of which:

FIG. 1 is a top perspective view of an electrical connector assembly;

FIG. 2 is a bottom perspective view of the electrical connector assembly of FIG. 1;

FIG. 3 is an exploded view of the electrical connector assembly of FIG. 1 showing an assembling process of the electrical connector assembly;

FIG. 4 is a cross-sectional view of the electrical connector assembly of FIG. 1;

FIG. 5 is an enlarged perspective view of a front end portion of the electrical connector assembly of FIG. 1;

FIG. 6 is a circuit diagram of an operation of the electrical connector assembly of FIG. 1; and

FIG. 7 is a graph showing an operation of the circuit of FIG. 6.

### DETAILED DESCRIPTION OF THE EMBODIMENT(S)

Hereinafter, embodiments of the present invention will be further described with reference to the accompanying drawings. In the following description, the same elements will be designated by the same reference numerals although they are shown in different drawings. Further, in the following description of embodiments of the present invention, a detailed description of known functions and configurations incorporated herein will be omitted when it may make the subject matter of the present invention rather unclear.

Also, to describe elements according to embodiments of the present invention, the terms first, second, A, B, (a), (b), etc. may be used herein. These terms are merely used to distinguish one element from another, but not to imply or suggest the substances, order or sequence of the elements. It will be understood that when an element is described as being “connected,” “coupled,” or “linked” to another element, it can be directly connected or coupled to the other element, or intervening elements may be present.

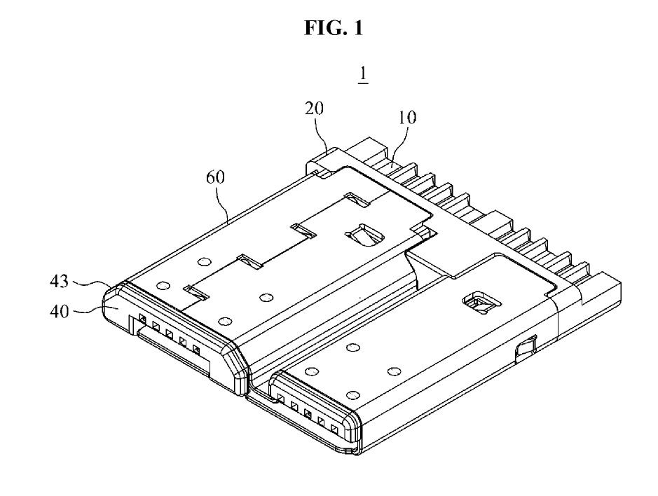

In the following description, the terms “front” and “rear” used herein will be described based on a direction in which the electrical connector assembly 1 is connected to a socket (not shown), wherein the front side is a mating end of the assembly 1, and the rear side is an opposite, conductor receiving end. The terms “top surface” and “bottom surface” used herein will be described based on a direction as shown in the drawings, for example, FIG. 1. The above terms are merely used to distinguish one element from another, but not to imply or suggest the substances, order or sequence of the elements.

According to embodiments, a plug complying with a universal serial bus (USB) 3.0 standard will be described as an example, however, one of ordinary skill in the art would appreciate that the invention is no limited thereto. Accordingly, one of ordinary skill in the art would appreciate that a plug is applicable to various standards, for example, a USB 3.0 micro-B type standard, a USB 2.0 standard, or a USB 2.0 micro-B type standard.

An electrical connector assembly 1 will now be described with reference to FIGS. 1 through 7. The electrical connector assembly 1 has a body 20, a housing 40, and a shell 60. A plurality of terminals 10, and a resistor device 30 may be positioned in the body 20. The housing 40 receives the body 20, and the shell 60 receives and covers the housing 40.

The terminals 10 electrically connect to a socket or a complementary mating connector to which the electrical connector assembly 1 is connected, and may include an input/output (I/O) terminal to interface with power or a neighboring device. The terminals 10 may include various pins based on a standard. In an embodiment, at least one of the terminals 10 includes a power terminal 11 through which power is input or output. Additionally, in an embodiment each of the terminals 10 includes a stepped portion 12 on an end, such that a portion of the terminal 10 is higher than an adjacent portion of the terminal 10.

Although the Figures disclose embodiment of the power terminal 11, one of ordinary skill in the art would appreciate that the positioning of the power terminal 11 in the assembly 1 is not limited by the drawings. Additionally, a shape of each of the terminals 10 is not limited by the embodiments disclosed in the Figures; rather, one of ordinary skill in the art would appreciate that the terminals 10 may have various shapes.

The terminals 10 may be insert-molded into the body 20, which is formed of a resin conducive to injection molding. To smoothly connect the terminals 10 to the socket or the mating connector, the terminals 10 may be partially exposed outside the front and rear sides body 20.

When the resistor device 30 is positioned in the body 20, the power terminal 11 includes at least one exposed portion positioned outside the body 20 to establish an electrical connection between the power terminal 11 and the resistor device 30. For example, the body 20 may include a resistor device receiving space 23 recessed by a predetermined size so that the resistor device 30 may be mounted in the resistor device receiving space 23. The exposed portion of the power terminal 11 may protrude outwardly from the resistor device receiving space 23, and is positioned outside the body.

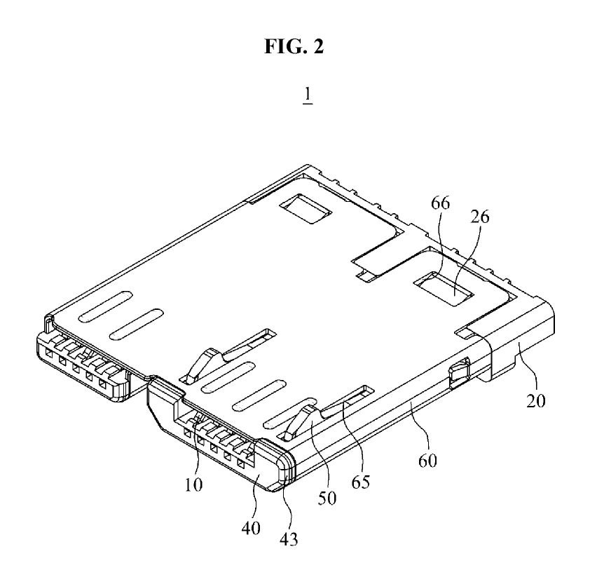

The body 20 and the shell 60 may be connected together through a fastener. In an embodiment, a first shell fastener 26 may be formed on side of the body 20 to fasten the body 20 with the shell 60. Additionally, a complementary second shell fastener 66 may be formed in the shell 60 to fasten the shell 60 with the body 20. The first shell fastener 26 and the second shell fastener 66 are complementarily shaped to be engaged with each other. For example, in an embodiment of FIG. 2, the first shell fastener 26 may have a hook shape, and the second shell fastener 66 may have a complementary hook receiving space. However, the present invention is not limited thereto, and one of ordinary skill in the art would appreciate that a shape, a location, and a size of each of the first shell fastener 26 and the second shell fastener 66 may be other fastener mechanisms.

In an embodiment, the resistor device 30 includes a positive temperature coefficient (PTC) device. Additionally, the resistor device 30 may be a polymeric PTC device or a ceramic PTC device. When the resistor device 30 is formed of a polymeric material, a space may be formed between the body 20 and the housing 40 such that temperature induced expansion of the resistor device 30 is tolerated. For example, the resistor device receiving space 23 of the body 20 may be greater than the size of the resistor device 30 and accordingly, a predetermined gap between an inner wall surface of the resistor device receiving space 23 and the resistor device 30 may be maintained.

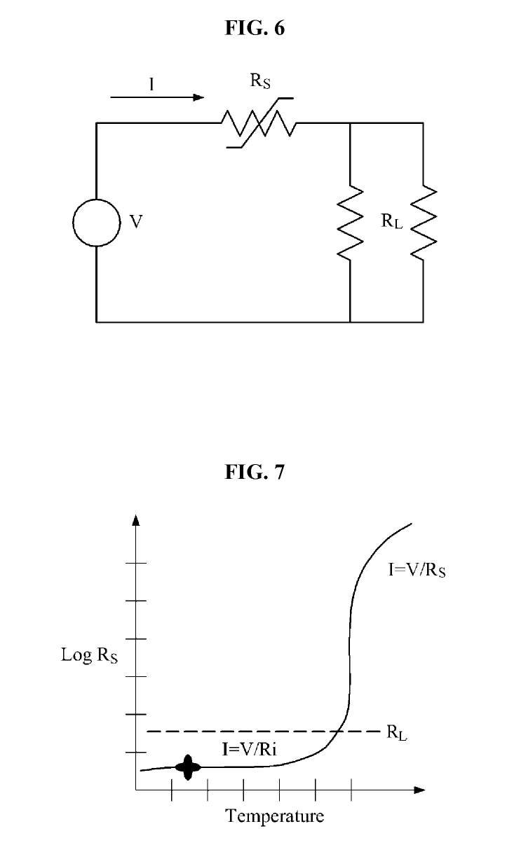

The resistor device 30 is connected to the power terminal 11, and functions as a switch to selectively block the power terminal 11. In the embodiments of FIGS. 6 and 7, a current I may have a value of “V/Ri” in a normal state. When overcurrent having a value greater than a predetermined value flows (I=V/Rs), resistance increases due to an increase in a temperature, and a PTC trip occurs. Additionally, when a PTC trip occurs in the resistor device 30, the applied overcurrent is eliminated because the circuit is now open, allowing the temperature to decrease. Accordingly, the resistance also decreases, so that the resistor device 30 returns to the normal state.

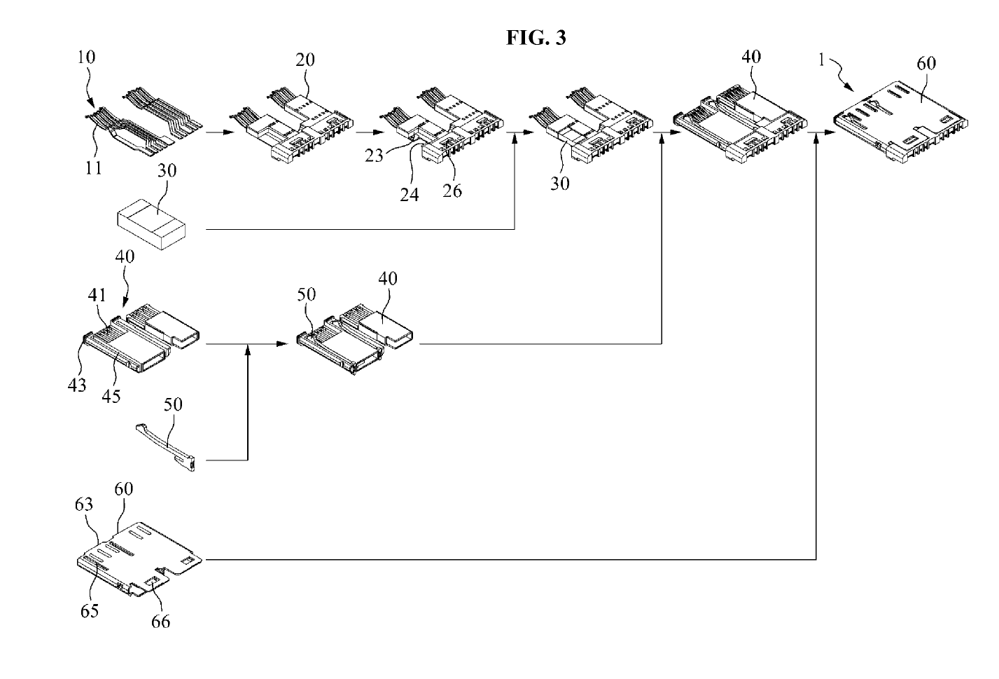

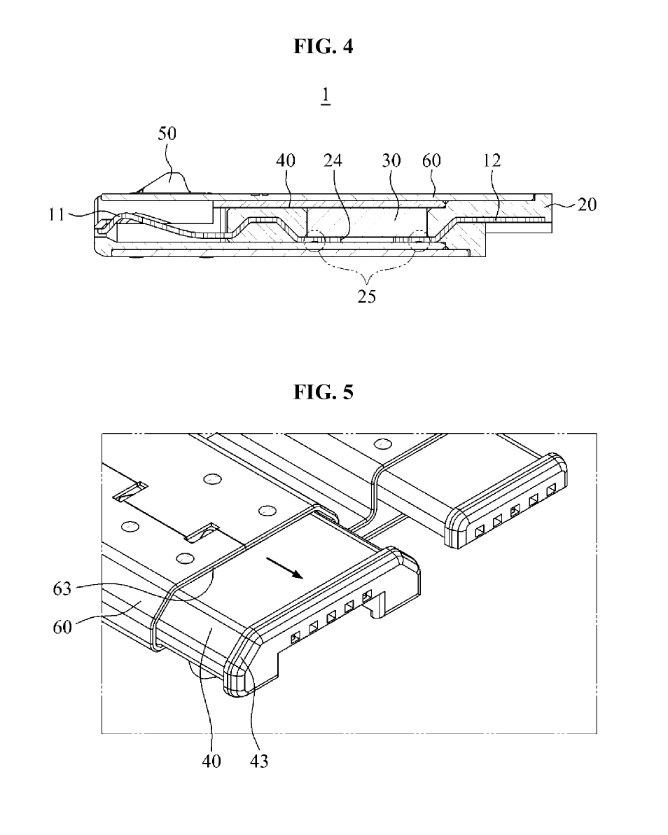

To selectively block the power terminal 11, a cut portion 24 of the power terminal 11 may be removed, and the cut portion 24 connected to the resistor device 30. As shown in the embodiments of FIGS. 3 and 4, the power terminal 11 may be completely cut, and the cut portion 24 is connected to the resistor device 30 through welding or soldering. An area in which the power terminal 11 and the resistor device 30 are in contact with each other is shown as a welded portion 25 in the embodiment of FIG. 4.

The housing 40 has a body receiving space (not labeled) wherein the body 20 is positioned, and consequently, also receives and supports the terminals 10. The portions of terminals 10 exposed outside the body 20 are free terminating ends (not labeled), and the housing 40 supports these free terminating ends. Accordingly, the housing 40 serves as a guide, allowing the electrical connector assembly 1 to be smoothly connected to a socket or a mating connector, while preventing the terminals 10 from being damaged during the mating process.

In the embodiment of FIG. 3, a terminal receiving portion 41 is formed to receive the terminals 10, and a lever receiving portion 45 is formed to receiving a locking lever 50.

The housing 40 forms a portion of an exterior of the electrical connector assembly 1 and is made of a nonconductive material or a resin material, to facilitate molding and to provide a stable platform to electrically connect the terminals 10.

The shell 60 has a housing receiving space (not labeled) and is slidingly connected to an outer surface of the housing 40. A rear side of the housing 40 is inserted into the housing receiving space of the shell 60. The shell 60 is made of a metallic material and forms the exterior surface of the electrical connector assembly 1, as well as providing structural strength.

The housing 40 include a stopper 43 positioned on a front end portion 63 of the housing 40. The stopper 43 limits a length of the shell 60 to be connected to the housing 40. The stopper 43 is formed of a resin material. During mating of the electrical connector assembly 1 with the socket or mating connector, the stopper 43 contacts the socket or the mating connector rather than the socket or mating connector contacting the metallic shell 60, being positioned between the mated socket or mating connector. Consequently, damage to the front portion 63 of the metallic shell 60 from the mating process is avoided.

In an embodiment, the stopper 43 protrudes outward from the housing 40 at a predetermined length, along the front end portion 63 of the housing 40. Additionally, the stopper 43 is partially or entirely positioned along the front end portion of the housing 40. When the housing 40 is inserted into the shell 60, the predetermined height of the stopper 43 is such that a surface of the stopper 43 and a surface of the shell 60 are on the same plane, permitting the exterior surface of the electrical connector assembly 1 to be substantially smooth.

The locking lever 50 connects the the electrical connector assembly 1 to the mating connector or the socket. In an embodiment of FIG. 3, at least one locking lever 50 having a hook (not labeled) may be provided to engage a complementary hook receiving space on the mating connector or the socket. In other embodiments (not shown), one of ordinary skill in the art would appreciate that a location and a shape of the locking lever 50 and a number of locking levers 50 may vary, and that a variety of known locks may be used, and well as a plurality of locking levers 50, such as two, three, four or more may also be used.

The locking lever 50 is positioned in the housing 40. In an embodiment of FIG. 3, the locking lever 50 is positioned in a lever receiving space (see generally: 65) in the shell 60, with a portion of the locking lever 50 extending outward therefrom. A lever fastener 65 connects the locking lever 50 to the shell 60.

In an embodiment, the electrical connector assembly 1 includes the resistor device 30 and accordingly, overcurrent can be prevented from occurring in the electrical connector assembly 1. Additionally, the electrical connector assembly 1 may effectively prevent an occurrence of overcurrent over a wide range of current levels, for example, a low current, overcurrent, or a rated current. Moreover, since the resistor device 30 is position in the electrical connector assembly 1, the dimensions of the electrical connector assembly 1 can be relatively small, while still prevent overcurrent from occurring in the electrical connector assembly 1. Furthermore, since the resistor device 30 is positioned proximate to a contact point of the terminals 10 in the electrical connector assembly 1, when heat is generated in the contact point, the sensitivity of the resistor device 30 is increased. In addition, the resistor device 30 may react to even low heat, due to the resistor device 30 being in close proximity to the contact point. Accordingly, the above embodiments disclose an electrical connector assembly 1 having an enhanced sensitivity and accuracy towards detecting an occurrence of overcurrent than that of conventional connector assemblies.

A number of examples have been described above. Nevertheless, one of ordinary skill in the art would appreciate that that various modifications may be made within the spirit and scope of the invention. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An electrical connector assembly comprising:
a body;
a plurality of terminals insert-molded in the body;
a resistor device positioned in the body and in contact with a power terminal;
a housing having a body receiving space into which the body is positioned; and
a shell connected to an outside of the housing.

2. The electrical connector assembly of claim 1, wherein the plurality of terminals includes a power terminal.

3. The electrical connector assembly of claim 2, wherein the power terminal includes at least one exposed portion positioned outside the body.

4. The electrical connector assembly of claim 3, wherein a cut portion is formed in the exposed portion of the power terminal.

5. The electrical connector assembly of claim 4, wherein the resistor device is connected to the cut portion of the power terminal.

6. The electrical connector assembly of claim 5, wherein the resistor device and the power terminal are welded or soldered together.

7. The electrical connector assembly of claim 1, wherein the shell is slidingly connected to the outside of the housing.

8. The electrical connector assembly of claim 1, wherein the housing further comprises a stopper positioned on an end portion.

9. The electrical connector assembly of claim 8, wherein the stopper protrudes from the housing.

10. The electrical connector assembly of claim 9, wherein the stopper is positioned between the shell and a mated complimentary socket or mating connector.

11. The electrical connector assembly of claim 7, wherein the stopper has a height such that a surface of the stopper is on the same plane as a surface of the shell when the shell is connected to the housing.

12. The electrical connector assembly of claim 1, wherein the shell is formed of a metallic material.

13. The electrical connector assembly of claim 1, wherein the housing is formed of a nonconductive material.

14. The electrical connector assembly of claim 1, further comprising a locking lever connected to the housing.

15. The electrical connector assembly of claim 14, wherein the locking lever includes a hook that engages a complementary hook receiving space on a mating connector or socket.

16. The electrical connector assembly of claim 1, wherein each of the terminals includes a stepped portion on an end such that a first portion of the terminal is higher than an adjacent portion of the terminal.

17. The electrical connector assembly of claim 1, wherein the resistor device comprises a polymeric Positive Temperature Coefficient (PTC) device or a ceramic PTC device.
